(19) United States
(12) Patent Application Publication
(10) Pub. No.: US 2018/0356514 A1
(43) Pub. Date: Dec. 13, 2018

(54) MOBILE BEACON FOR LOCATING BUILDING OCCUPANTS

(71) Applicant: Carrier Corporation, Palm Beach Gardens, FL (US)

(72) Inventors: Vijaya Ramaraju Lakamraju, Longmeadow, MA (US); Alberto Speranzon, Maple Grove, MN (US)

(21) Appl. No.: 15/781,806

(22) PCT Filed: Nov. 30, 2016
(86) PCT No.: PCT/US2016/064078

§ 371 Date: Jun. 6, 2018

Related U.S. Application Data
(60) Provisional application No. 62/264,567, filed on Dec. 8, 2015.

(51) Int. Cl. G01S 13/87; G01S 5/14; G01S 5/02

(52) U.S. Cl. CPC G01S 13/878; G01S 5/0036; G01S 5/0289; G01S 5/14

(57) ABSTRACT

A method and apparatus for a locating building occupants is provided, the system including at least one fixed beacon device to transmit a fixed beacon signal, at least one mobile device including at least one beacon enabled mobile device, wherein the at least one beacon enabled mobile device transmits a mobile beacon signal and the at least one mobile device transmits a response signal in response to at least one of the fixed beacon signal and the mobile beacon signal, and a processor to determine a location of the at least one mobile device by analyzing the response signal.

### DESCRIPTION OF RELATED ART

The subject matter disclosed herein relates to locating building occupants, and to a system and a method for locating building occupants via a mobile beacon.

Typically, the location of occupants within a building can be utilized by building managers to make decisions about building services. For example, building managers may estimate occupant locations to determine efficient energy usage. Further, during emergency events, the location of occupants within a building can be utilized by first responders to make decisions about evacuations and rescue operations. Advantageously, information regarding the location of occupants within the building can facilitate improved services such as elevator dispatch.

Occupant location systems are often used in buildings to monitor the location of occupants by utilizing mobile devices such as mobile phones. Current location systems may utilize fixed beacons to locate occupants, but may not provide enough resolution and range to accurately locate all occupants. A system and method that can provide an occupant location system with greater resolution and range is desired.

### BRIEF SUMMARY

According to an embodiment, a localization system is provided, the system including at least one fixed beacon device to transmit a fixed beacon signal, at least one mobile device including at least one beacon enabled mobile device, wherein at least one beacon enabled mobile device transmits a mobile beacon signal the at least one mobile device transmits a response signal in response to at least one of the fixed beacon signal and the mobile beacon signal, and a processor to determine a location of the at least one mobile device by analyzing the response signal.

In addition to one or more of the features described above, or as an alternative, further embodiments could include that the processor determines the location of the at least one mobile device by performing a time of flight calculation.

In addition to one or more of the features described above, or as an alternative, further embodiments could include that each of the fixed beacon signal, the mobile beacon signal, and the response signal include at least of a long range signal and a short range signal.

In addition to one or more of the features described above, or as an alternative, further embodiments could include that each of the fixed beacon signal, the mobile beacon signal, and the response signal include at least of a Wi-Fi signal, a Bluetooth signal, and a near field communication signal.

In addition to one or more of the features described above, or as an alternative, further embodiments could include that the user interface of at least one mobile device includes a user interface to validate the location of the at least one mobile device.

In addition to one or more of the features described above, or as an alternative, further embodiments could include that the at least one mobile device is selectively enabled as the at least one beacon enabled mobile device.

In addition to one or more of the features described above, or as an alternative, further embodiments could include that the at least one mobile device includes a map to validate the location of the at least one mobile device.

In addition to one or more of the features described above, or as an alternative, further embodiments could include that the processor engages a plurality of subsets of the at least one beacon enabled mobile device.

In addition to one or more of the features described above, or as an alternative, further embodiments could include that the processor engages an event mode.

According to an embodiment, a method to locate at least one mobile device includes providing at least one fixed beacon device, transmitting a fixed beacon signal via the at least one fixed beacon device, providing the at least one mobile device including at least one beacon enabled mobile device, transmitting a mobile beacon signal via the at least one beacon enabled mobile device, receiving at least one of the fixed beacon signal and the mobile beacon signal via the at least one mobile device, transmitting a response signal via the at least one mobile device in response to the at least one fixed beacon signal and the mobile beacon signal, analyzing the response signal via a processor, and determining a location of the at least one mobile device via the processor.

In addition to one or more of the features described above, or as an alternative, further embodiments could include engaging a building operation mode via the processor.

In addition to one or more of the features described above, or as an alternative, further embodiments could include engaging an event mode via the processor.

In addition to one or more of the features described above, or as an alternative, further embodiments could include validating the location of the at least one mobile device via a user interface on the mobile device.

In addition to one or more of the features described above, or as an alternative, further embodiments could include enabling the at least one mobile device as the at least one beacon enabled mobile device via the user interface.

In addition to one or more of the features described above, or as an alternative, further embodiments could include validating the location of the at least one mobile device via a map of the user interface.

Technical function of the embodiments described above includes at least one beacon enabled mobile device, wherein the at least one beacon enabled mobile device transmits a mobile beacon signal.

Other aspects, features, and techniques of the embodiments will become more apparent from the following description taken in conjunction with the drawings.

### BRIEF DESCRIPTION OF THE SEVERAL VIEWS OF THE DRAWINGS

The subject matter is particularly pointed out and distinctly claimed in the claims at the conclusion of the specification. The foregoing and other features, and advantages of the embodiments are apparent from the following detailed description taken in conjunction with the accompanying drawings in which like elements are numbered alike in the several FIGURES:

FIG. 1 illustrates a schematic view of an occupant locating system; and

FIG. 2 is a flow diagram of a method of locating occupants within a building.

### DETAILED DESCRIPTION

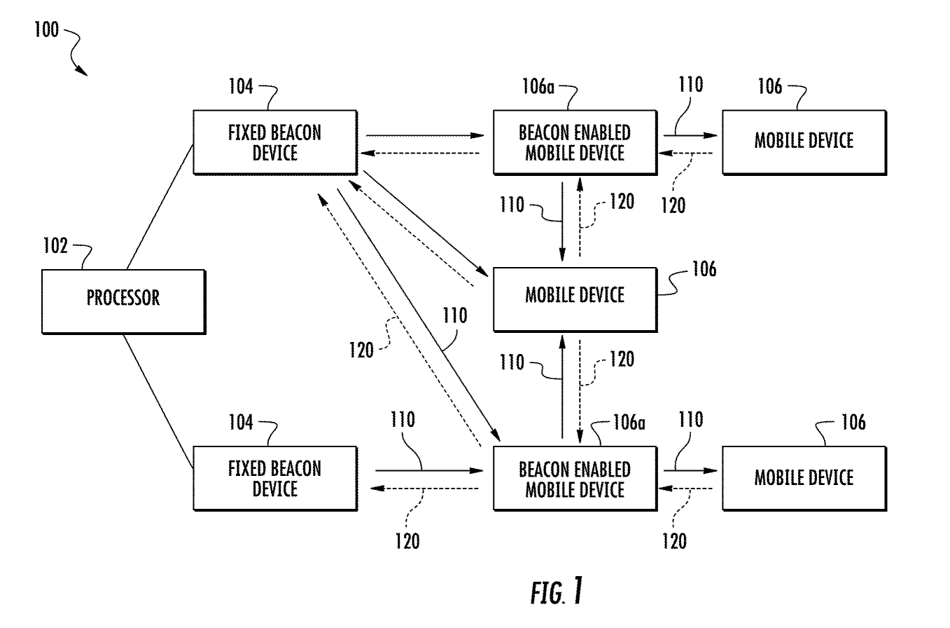

Referring now to the drawings, FIG. 1 illustrates a schematic view of an occupant locating system 100 suitable for use with a building or any other suitable location. In the illustrated embodiment, the occupant locating system 100 includes a processor 102, fixed beacon devices 104 and mobile devices 106. In the illustrated embodiment, at least one of the mobile devices 106 can be a beacon enabled mobile device 106a. In the illustrated embodiment, the occupant locating system 100 can be utilized to locate beacon enabled mobile devices 106a and mobile devices 106 associated or corresponding to building occupants. Advantageously, the occupant locating system 100 can utilize beacon enabled mobile devices 106a to provide enhanced accuracy and increased functionality compared to traditional building occupant locating systems.

In the illustrated embodiment, fixed beacon devices 104 provide beacon signals 110 to beacon enabled mobile devices 106a and mobile devices 106 and can receive response signals 120 from beacon enabled mobile devices 106a and mobile devices 106. In the illustrated embodiment, the fixed beacon device 104 can be a wireless router or any other suitable device that can wirelessly communicate with both beacon enabled mobile devices 106a and mobile devices 106. In certain embodiments the fixed beacon device 104 can be in a known location. In the illustrated embodiment, the fixed beacon devices 104 can provide an anchor point for the occupant locating system 100. Furthermore, in certain embodiments, the processing can also happen in each of the mobile device 106, as responses are obtained and forwarded from other devices.

In the illustrated embodiment, mobile devices 106 can be carried, held or otherwise associated with building occupants. In the illustrated embodiment, the mobile devices 106 can be mobile phones, access cards, key fobs, etc. or otherwise any suitable device that is associated with each building occupant to provide a representative location of each building occupant. Therefore, mobile devices 106 can be utilized to provide locations to the occupant locating system 100. In certain embodiments, building occupants can opt in to utilizing the occupant locating system 100 by downloading an app, toggling a setting, etc.

In certain embodiments the mobile device 106 can display or utilize a user interface to interact with the occupant locating system 100. In certain embodiments, the mobile device 106 can provide information regarding an associated occupant's current location, as well as other building occupant locations, such as coworkers, friends, relatives, etc. In certain embodiments, selected information is shown and validated in a user interface such as a map, while in other embodiments, selected information is provided as proximity alerts.

In the illustrated embodiment, the mobile device 106 can provide a response signal 120 in response to a beacon signal 110. In the illustrated embodiment, the mobile device 106 can provide a response signal 120 to the interrogating device that provided the beacon signal 110. In the illustrated embodiment, the interrogating device can include, but is not limited to, the fixed beacon device 104 or the beacon enabled mobile device 106a.

In the illustrated embodiment, at least one of the mobile devices 106 can include beacon enabled mobile devices 106a. In the illustrated embodiment, a beacon enabled mobile device 106a can provide the same functions as the mobile device 106 but can further transmit beacon signals 110. In certain embodiments, all mobile devices 106 can be enabled as beacon enabled mobile devices 106a. In certain embodiments, beacon enabled mobile devices 106a can be selectively enabled by occupants opting in via a user interface. In certain embodiments, beacon enabled mobile devices 106a can be automatically enabled in response to a trigger signal. In certain embodiments, beacon enabled mobile devices 106a can be selectively enabled and disabled as required. In certain embodiments, beacon enabled mobile devices 106a can be purpose built devices.

In the illustrated embodiment, the beacon enabled mobile devices 106a can provide response signals 120 to beacon signals 110 as described with respect to mobile devices 106. Further, in the illustrated embodiment, the beacon enabled mobile devices 106a can provide beacon signals 110. In the illustrated embodiment, a beacon enabled mobile device 106a will not respond to its own beacon signal 110.

In the illustrated embodiment, the beacon enabled mobile devices 106a can provide a beacon signal 110 and receive a response signal 120. Similar to the fixed beacon devices 104, the beacon enabled mobile devices 106a can be utilized to determine a relative location of the other mobile devices 106 and other beacon enabled mobile devices 106a. In the illustrated embodiment, location information associated with the received response signals can be combined with information received from fixed beacon devices 104 to determine occupant positions with greater accuracy and resolution. In certain embodiments, the use of beacon enabled mobile devices 106a can provide greater operating range for the occupant locating system 100 since mobile devices 106 may be out of range of a fixed beacon device 104 but within range of a beacon enabled mobile device 106a. In certain embodiments, various subsets of beacon enabled mobile devices 106a can be selectively enabled over short periods of time. Advantageously, this can provide differentiated signaling information to the processor 102 for additional information fidelity.

Advantageously, the use of beacon enabled mobile devices 106a can create a mesh network of anchor points or beacon devices. In the illustrated embodiment, beacon enabled mobile devices 106a can work in conjunction with fixed beacon devices 104 to provide additional information to allow for greater accuracy and room level locating capabilities without increase overall system costs.

In the illustrated embodiment, both the fixed beacon device 104 and the beacon enabled mobile devices 106a can transmit beacon signals 110. In the illustrated embodiment, the beacon signals 110 provide a broadcast signal to query or interrogate mobile devices 106,106a to provide a response signal 120. In certain embodiments, the beacon signals 110 can be short range signals such as near field communication signals, RFID signals, and Bluetooth signals, while in other embodiments, the beacon signals 110 can be longer range signals such as Wi-Fi signals, cellular signals, etc.

In response to the received beacon signals 110, the mobile devices 106,106a can transmit a response signal 120 back to the fixed beacon device 104 or the beacon enabled mobile device 106a that previously transmitted the corresponding beacon signal 110. In the illustrated embodiment, the response signals 120 can be the same short range signals such as near field communication signals, RFID signals, and Bluetooth signals, while in other embodiments, the response signals 120 can be longer range signals such as Wi-Fi signals, cellular signals, etc. In certain embodiments, the response signals 120 can be utilized to locate or triangulate the location of mobile devices 106,106a by utilizing time of flight calculations or other location calculations.

In the illustrated embodiment, the processor 102 can receive the response signal 120 information from the fixed beacon devices 104 and the beacon enabled mobile devices 106a. In certain embodiments, the processor 102 can be a separate device from the mobile devices 106, 106a. In other embodiments, the processor 102 can be integrated with the mobile devices 106, 106a. In certain embodiments, the information regarding the beacon signals 110 is also received by the processor 102. In the illustrated embodiment, the processor can analyze the timing, strength, and other characteristics of the received response signals 120 to determine the position of the mobile devices 106,106a. In certain embodiments, the processor 102 can utilize time of flight calculations with respect to the response signals 120 to determine the location of the mobile devices 106, 106a. In certain embodiments, the processor 102 can further utilize triangulation, echo calculation, etc. to determine the location of the mobile devices 106, 106a. In certain embodiments, the processor 102 can further utilize qualitative information of the mobile device 106,106a. For example, the processor 102 can utilize the general location or presence of mobile devices 106, 106a to determine location of the mobile devices 106,106a. In the illustrated embodiment, the processor 102 can utilize known location parameters of the fixed beacon devices 104 to determine locations of mobile devices 106,106a relative to the fixed beacon devices 104. In certain embodiments, the processor 102 can utilize the relative locations of the beacon enabled mobile devices 106a with respect to the fixed beacon devices 104 to determine locations of the beacon enabled mobile devices 106a. In the illustrated embodiment, the processor 102 can determine locations of mobile devices 106 relative to the locations of the beacon enabled mobile devices 106a to determine proximity of certain occupants. In certain embodiments, the location of the mobile devices 106 can be determined relative to fixed beacon devices 104 by first determining a location of a mobile device 106 relative beacon enabled mobile device 106a and then determining the location of the beacon enabled mobile device 106a relative to the fixed beacon devices 104. In certain embodiments, the processor 102 can enable various subsets of the beacon enabled mobile devices 106a at various periods of time. In certain embodiments, the processor 102 can utilize the differentiated signaling information to provide additional location information.

In the illustrated embodiment, the processor 102 can operate the occupant locating system 100 in multiple modes. In the illustrated embodiment, the processor 102 can engage in a normal building operation mode. During normal operation, the processor 102 can utilize location information determined from the response signals 120 to determine occupant locations within the building to control HVAC equipment, airflow, temperature, humidity, access policies, energy control, lights, etc.

In response to an event, such as a fire, agent release, the processor 102 can engage in an event mode. In certain embodiments, an operator can engage the event mode. During event operation, the processor 102 can utilize location data of occupants to provide information to first responders regarding the location of occupants, model the flow of occupants through the building, track the entry and exit of occupants through the building, dictate safe elevator usage, determine fire and chemical agent propagation, etc. In certain embodiments, occupant location data can be utilized to prioritize search and rescue efforts.

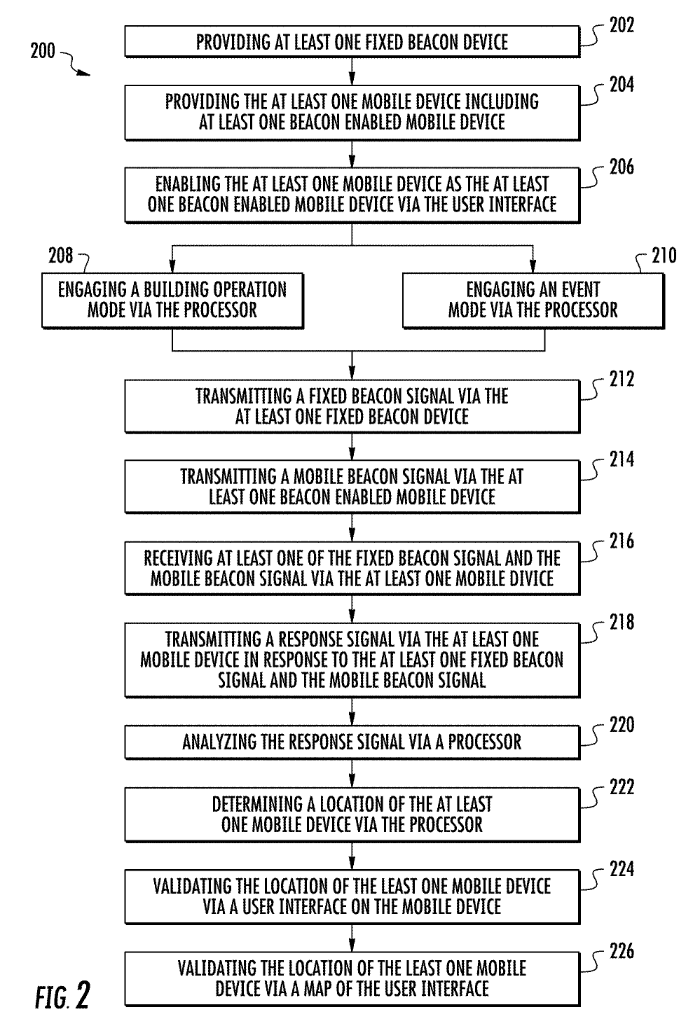

FIG. 2 illustrates a method 200 to locate occupants within a building. In operation 202, at least one fixed beacon device is provided. In the illustrated embodiment, fixed beacon devices provide beacon signals to beacon enabled mobile devices and mobile devices and can receive response signals from beacon enabled mobile devices and mobile devices. In the illustrated embodiment, the fixed beacon device can be a wireless router or any other suitable device located in a known location.

In operation 204, at least one mobile device is provided. In the illustrated embodiment, mobile devices can be associated with building occupants. Further, certain occupants may be associated with at least one beacon enabled mobile device. In the illustrated embodiment, mobile devices can be carried, held or otherwise associated with building occupants. In the illustrated embodiment, the mobile devices can be mobile phones, access cards, key fobs, etc. or otherwise any suitable device that is associated with each building occupant to provide a representative location of each building occupant.

In operation 206, the at least one mobile device can be enabled or otherwise selected as the at least one beacon enabled mobile device via the user interface. In certain embodiments, beacon enabled mobile devices can be selectively enabled by occupants opting in via a user interface. In the illustrated embodiment, a beacon enabled mobile device can continue to provide the same functions as the mobile device but can further transmit beacon signals. In certain embodiments, beacon enabled mobile devices can be automatically enabled in response to a trigger signal. In certain embodiments, beacon enabled mobile devices can be selectively enabled and disabled as required.

In operation 208, a building operation mode can be engaged via the processor. During normal operation, the processor can utilize location information determined from the response signals to determine occupant locations within the building to control HVAC equipment, airflow, temperature, humidity, access policies, energy control, lights, etc.

In operation 210, an event mode can be engaged via the processor. In response to an event, such as a fire, agent release, the processor can engage in an event mode. During event operation, the processor can utilize location data of occupants to provide information to first responders regarding the location of occupants, model the flow of occupants through the building, track the entry and exit of occupants through the building, dictate safe elevator usage, determine fire and chemical agent propagation, etc.

In operation 212, a fixed beacon signal is transmitted via the at least one fixed beacon device. In the illustrated embodiment, the fixed beacon device can transmit beacon signals. In the illustrated embodiment, the beacon signals provide a broadcast signal to query or interrogate mobile devices to provide a response signal.

In operation 214, a mobile beacon signal is transmitted via the at least one beacon enabled mobile device. In the illustrated embodiment, the beacon enabled mobile devices can transmit beacon signals. In the illustrated embodiment, the beacon signals provide a broadcast signal to query or interrogate mobile devices to provide a response signal. In operation 216, at least one of the fixed beacon signal and the mobile beacon signal is received via the at least one mobile device.

In operation 218, a response signal is transmitted via the at least one mobile device in response to the at least one fixed beacon signal and the mobile beacon signal. In response to the received beacon signals, the mobile devices can transmit a response signal back to the fixed beacon device or the beacon enabled mobile device that previously transmitted the corresponding beacon signal.

In operation 220, the response signal is analyzed via a processor. In operation 222, a location of the at least one mobile device is determined via the processor. In the illustrated embodiment, the processor can analyze the timing, strength, and other characteristics of the received response signals to determine the position of the mobile devices.

In operation 224, the location of the at least one mobile device can be validated via a user interface on the mobile device. In certain embodiments, the mobile device can provide information regarding an associated occupant's current location, as well as other building occupant locations, such as coworkers, friends, relatives, etc. that can be reviewed by users and occupants.

In operation 226, the location of the at least one mobile device can be validated via a map within the user interface. In certain embodiments, selected information is shown and validated in a user interface such as a map, while in other embodiments; selected information is provided as proximity alerts.

The terminology used herein is for the purpose of describing particular embodiments only and is not intended to be limiting of the embodiments. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope of the embodiments. Additionally, while various embodiments have been described, it is to be understood that aspects may include only some of the described embodiments. Accordingly, the embodiments are not to be seen as limited by the foregoing description, but are only limited by the scope of the appended claims.

1. A localization system, comprising:
at least one fixed beacon device to transmit a fixed beacon signal;
at least one mobile device including at least one beacon enabled mobile device, wherein the at least one beacon enabled mobile device transmits a mobile beacon signal and the at least one mobile device transmits a response signal in response to at least one of the fixed beacon signal and the mobile beacon signal; and
a processor to determine a location of the at least one mobile device by analyzing the response signal.

2. The localization system of claim 1, wherein the processor determines the location of the at least one mobile device by performing a time of flight calculation.

3. The localization system of claim 1, wherein each of the fixed beacon signal, the mobile beacon signal, and the response signal include at least of a long range signal and a short range signal.

4. The localization system of claim 1, wherein each of the fixed beacon signal, the mobile beacon signal, and the response signal include at least of a Wi-Fi signal, a Bluetooth signal, and a near field communication signal.

5. The localization system of claim 1, wherein the at least one mobile device includes a user interface to validate the location of the at least one mobile device.

6. The localization system of claim 1, wherein the at least one mobile device is selectively enabled as the at least one beacon enabled mobile device.

7. The localization system of claim 1, wherein the at least one mobile device includes a map to validate the location of the at least one mobile device.

8. The localization system of claim 1, wherein the processor engages a plurality of subsets of the at least one beacon enabled mobile device.

9. The localization system of claim 1, wherein the processor engages an event mode.

10. A method to locate at least one mobile device, the method comprising:
providing at least one fixed beacon device;
transmitting a fixed beacon signal via the at least one fixed beacon device;
providing the at least one mobile device including at least one beacon enabled mobile device;
transmitting a mobile beacon signal via the at least one beacon enabled mobile device;
receiving at least one of the fixed beacon signal and the mobile beacon signal via the at least one mobile device;
transmitting a response signal via the at least one mobile device in response to the at least one fixed beacon signal and the mobile beacon signal;
analyzing the response signal via a processor; and
determining a location of the at least one mobile device via the processor.

11. The method of claim 10, further comprising engaging a building operation mode via the processor.

12. The method of claim 10, further comprising engaging an event mode via the processor.

13. The method of claim 10, further comprising validating the location of the at least one mobile device via a user interface on the mobile device.

14. The method of claim 13, further comprising enabling the at least one mobile device as the at least one beacon enabled mobile device via the user interface.

15. The method of claim 13, further comprising validating the location of the at least one mobile device via a map of the user interface.
